(19) United States
(12) Patent Application Publication
(10) Pub. No.: US 2015/0006763 A1
(43) Pub. Date: Jan. 1, 2015

(54) ELECTRONIC DEVICE, CONTROL METHOD OF ELECTRONIC DEVICE AND CONTROL PROGRAM OF ELECTRONIC DEVICE

(71) Applicant: Kabushiki Kaisha Toshiba, Tokyo (JP)

(72) Inventor: Akio Kanou, Ome-shi (JP)

(73) Assignee: Kabushiki Kaisha Toshiba, Tokyo (JP)

(21) Appl. No.: 14/169,532

(22) Filed: Jan. 31, 2014

(30) Foreign Application Priority Data
Jun. 28, 2013 (JP) 2013-137224

(51) Int. Cl. G06F 13/38

(52) U.S. Cl. CPC G06F 13/385
USPC 710/14

(57) ABSTRACT

According to one embodiment, electronic device includes: an certification module configured to use certifying information outputted from a certification device including a use certifying function of the electronic device to certify the certification device; and a control module configured to control the electronic device to be charged or discharged in accordance with modes previously set to the electronic device when the certification device is not certified.

### CROSS REFERENCE TO RELATED APPLICATION(S)

The application is based upon and claims the benefit of priority from Japanese Patent Application No. 2013-137224 filed on Jun. 28, 2013, the entire contents of which are incorporated herein by reference.

### BACKGROUND

1. Field

The present invention relates to an electronic device, a control method of an electronic device and a control program of an electronic device.

2. Description of the Related Art

In recent years, electronic devices such as personal computers (PC), tablet computers (tablet) and smart phones are popularized.

In these electronic devices, valuable information of users is properly handled.

Accordingly, a countermeasure is taken that, for instance, a password is set to certify a user (a certification of a password) so that the security of the electronic device may be improved.

Then, when a note PC (a personal computer) is activated, an OS (operating system) is ordinarily activated after, for instance, the certification of the password is carried out.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a diagram showing external appearances of an electronic device (a PC) and a certification device (a wearable device) according to an exemplary embodiment.

FIG. 2 is a block diagram showing a schematic structure of the electronic device (PC) and the certification device (the wearable device) according to the exemplary embodiment.

FIG. 3 is a block diagram showing a structure of the electronic device (the PC) according to the exemplary embodiment.

FIGS. 4A and 4B are diagrams showing an example of a structure of a control part which is provided in the electronic device (the PC) according to the exemplary embodiment to control a charge/discharge of a device of its own.

FIG. 5 is a diagram showing a state that a mode for controlling a charge/discharge of the device of its own which is set to the electronic device (the PC) according to the exemplary embodiment is displayed and outputted to a display part of the electronic device (the PC) when the certification device (the wearable device) is not certified.

FIG. 6 is a flowchart for explaining an operation of the electronic device (the PC) according to the exemplary embodiment.

### DETAILED DESCRIPTION

According to one embodiment, electronic device includes: an certification module configured to use certifying information outputted from a certification device including a use certifying function of the electronic device to certify the certification device; and a control module configured to control the electronic device to be charged or discharged in accordance with modes previously set to the electronic device when the certification device is not certified.

Now, referring to the drawings, an exemplary embodiment of the present invention will be described below.

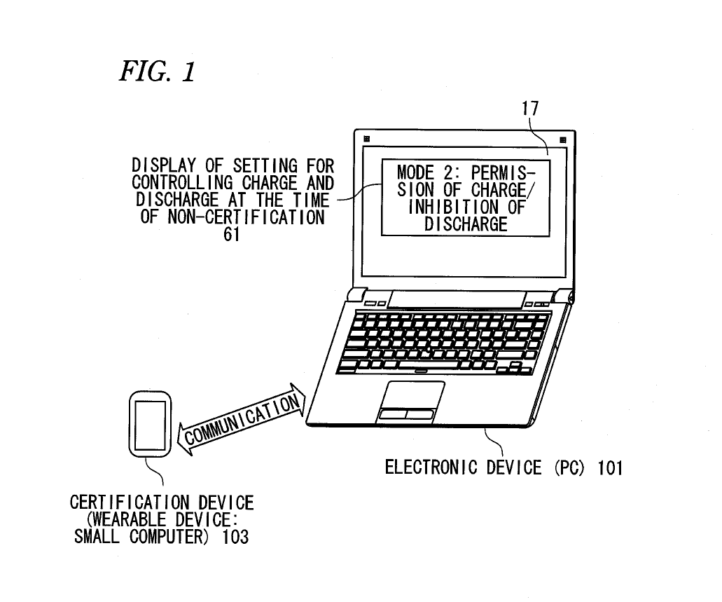

FIG. 1 is a diagram showing external appearances of an electronic device (a PC) and a certification device (a wearable device) according to an exemplary embodiment.

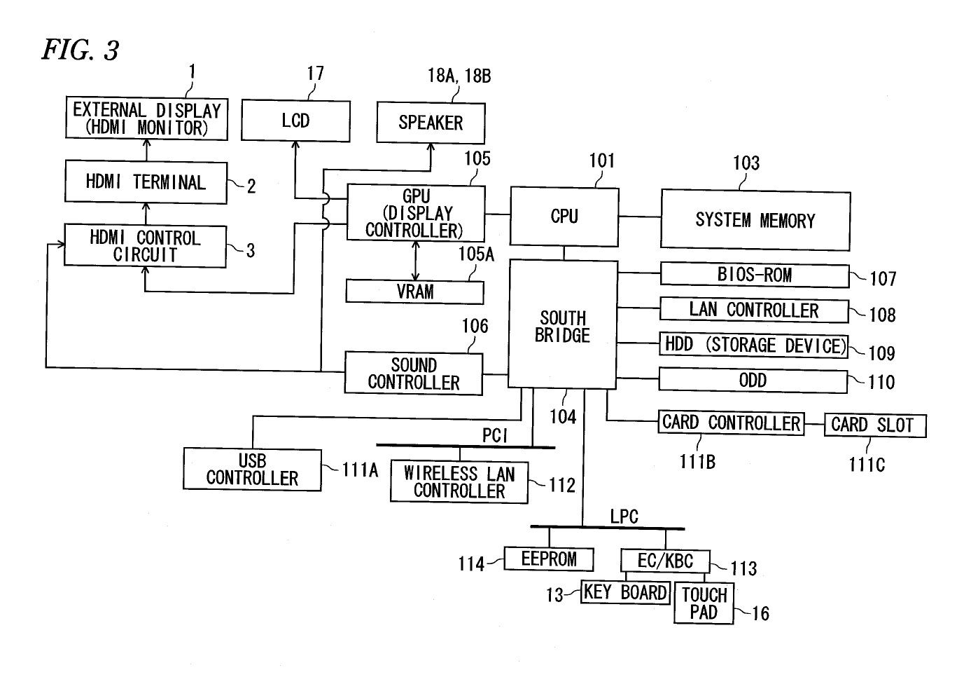

In this exemplary embodiment, the electronic device (the PC) 101 includes a certification part (a CPU 101, see FIG. 3) which uses certifying information outputted from the certification device (the wearable device: a small computer) 103 having a use certifying function of the device of its own to certify the certification device.

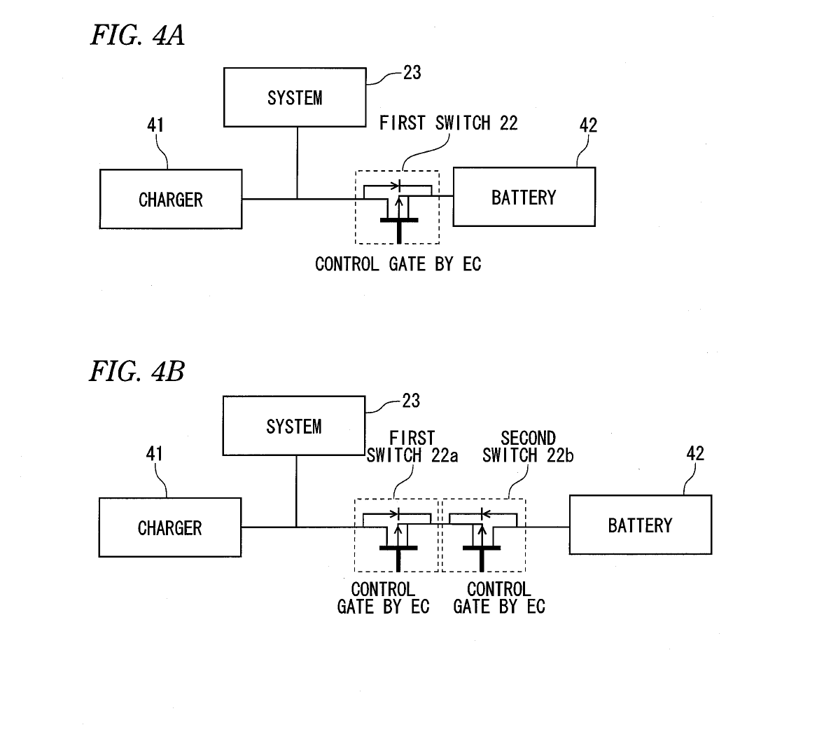

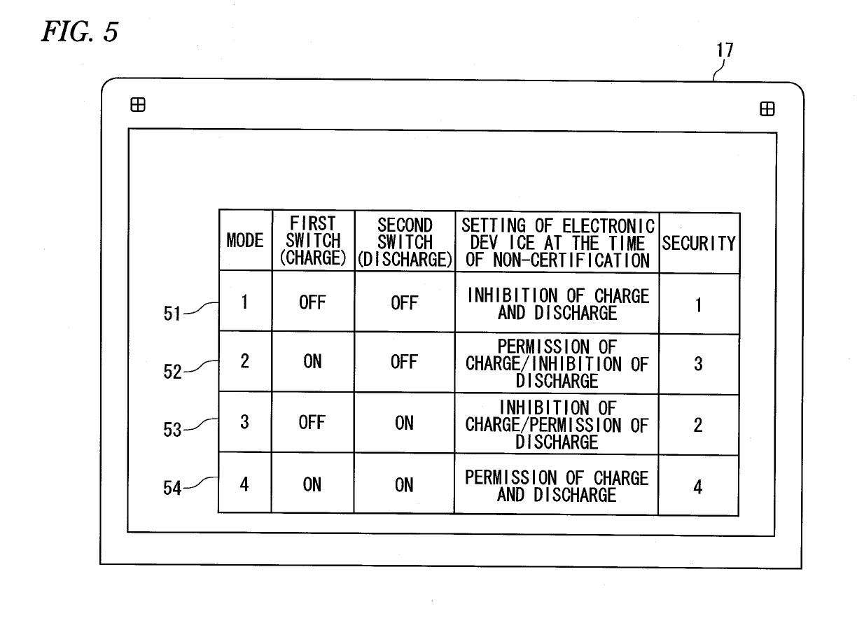

Further, the electronic device 101 includes a control part (see FIGS. 4A and 4B) which charges or discharges the device of its own or controls the device of its own to be charged or discharged in accordance with a mode (see FIG. 5) previously set to the device of its own when the certification device 103 is not certified.

As shown in FIG. 1, the electronic device (the PC) 101 carries out a communication with the certification device (the wearable device: the small computer) 103 by, for instance, radio wave.

Here, the certification device 103 has a function which can certify a use for the electronic device (the PC) 101 and the certifying information (for instance, an ID) of the certification device 103 is outputted to the electronic device (the PC) 101 from the certification device 103.

Then, the electronic device (the PC) 101 uses the certifying information outputted from the certification device (the wearable device: the small computer) 103 having the use certifying function of the device of its own to certify the certification device 103.

Further, when the certification device 103 is not certified, the electronic device (the PC) 101 charges or discharges the device of its own or controls the device of its own to be charged or discharged in accordance with a mode previously set to the device of its own.

Further, as shown in FIG. 1, in the present exemplary embodiment, a display 61 of a setting for controlling charging and discharging operations when the certification device 103 is not certified (at the time of a non-certification) is shown on a display part 17 of the electronic device (the PC) 101.

The setting for controlling the charging and discharging operations is previously set to, for instance, an EEPROM 114 (see FIG. 3) of the electronic device (the PC) 101.

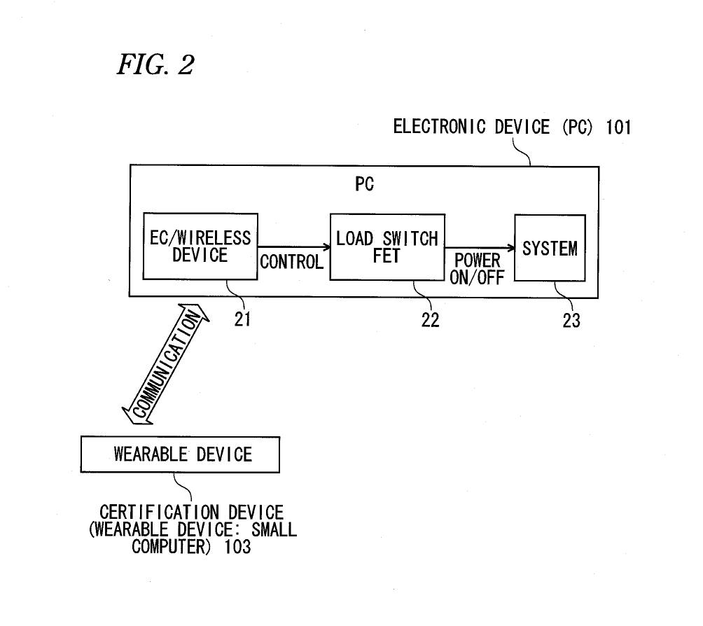

FIG. 2 is a block diagram showing a schematic structure of the electronic device (PC) according to the exemplary embodiment and the certification device (the wearable device).

As shown in FIG. 2, the certification device (the wearable device) 103 and the electronic device (the PC) 101 can carry out a communication by using, for instance, a wireless communication.

Here, the certification device (the wearable device) according to the present exemplary embodiment can use, for instance, a wearable computer.

The wearable computer indicates a computer which a user can wear and carry.

The wearable computer (the wearable device) is ordinarily formed with a small and light device. The wearable computer is widely studied which ranges from, for instance, a device using a gadget which the user ordinarily wears such as a wrist watch, a gadget which does not make the user impossible to wear and go outside such as a head mount display (HMD) or a computer combined with clothing.

Further, here, as the certification device (the wearable device), a portable telephone, a portable game machine or an IC card may be used.

Here, the electronic device (the PC) 101 includes, for instance, an EC/wireless device 21, a load switch FET 22 and a system 23.

Then, in the present exemplary embodiment, since the certification device (the wearable device) 103 and the electronic device (the PC) 101 carry out, for instance, such a wireless communication, when the certification device (the wearable device) 103 is located within a prescribed range (can be suitably set, for instance, 1 m or the like) where the electronic device (the PC) 101 can certify the certification device, a charging and discharging line in the electronic device (the PC) 101 is controlled to be tuned ON/OFF.

The charging and discharging line can be controlled by controlling the load switch EFT 22 of the charging and discharging line in accordance with, for instance, a GPIO signal (General Purpose Input/Output) outputted from the EC/wireless device 21 which carries out a communication with the certification device (the wearable device) 103.

Here, the EC indicates an embedded controller.

Further, the load switch EFT is formed with, for instance, an MOSFET as a switch which controls a line for supplying an electric power to an LSI or a motor to be turned ON/OFF.

The MOSFET is a voltage control device which is known as a load switch having excellent features that a driving circuit is simple, a charging current does not need to be basically supplied to a gate and an ON voltage is very low.

Further, here, for instance, when the charging and discharging line is turned OFF, a power source of an EC/communication module needs to be turned on. Accordingly, a discharging line from a battery is desired to be provided for a device necessary for a communication.

FIG. 3 is a block diagram showing a structure of the electronic device (the PC) according to the exemplary embodiment.

As shown in FIG. 3, the electronic device (the PC) 101 includes a CPU (a central processing unit) 101, a system memory 103, a south bridge 104, a GPU (a Graphics Processing Unit) 105, a VRAM (a video RAM: random access memory) 105A, a sound controller 106, a BIOS-ROM (a basic input/output system-read only memory) 107, a LAN (a local area network) controller 108, a hard disk drive (a HDD (storage device)) 109, an optical disk drive (ODD) 110, a USB controller 111A, a card controller 111B, a card slot 111C, a wireless LAN controller 112, an embed controller/keyboard controller (EC/KBC) 113 and an EEPROM (an electrically erasable programmable ROM) 114.

The CPU 101 is a processor for controlling operations of parts respectively in the electronic device (the PC) 101.

The CPU 101 carries out a BIOS stored in the BIOS-ROM 107. The BIOS is a program for controlling hardware. In the CPU 101, a memory controller is also incorporated which controls an access to the system memory 103. Further, the CPU 101 has a function for carrying out a communication with the GPU 105 through, for instance, a serial bus of a PCI EXPRESS standard.

The GPU 105 is a display controller which controls an LCD 17 used as a display monitor of the electronic device (the PC) 101.

A display signal generated by the GPU 105 is sent to the LCD 17. Further, the GPU 105 can transmit a digital video signal to an external display 1 through an HDMI (a registered trademark) control circuit 3 and an HDMI(a registered trademark) terminal 2.

The HDMI (the registered trademark) terminal 2 is a connecting terminal of the above-described external display. The HDMI (the registered trademark) terminal 2 can transmit a non-compressed digital video signal and a digital audio signal to the external display 1 such as a television by one cable. The HDMI (the registered trademark) control circuit 3 is an interface which transmits the digital video signal to the external display 1 referred to as an HDMI (a registered trademark) monitor through the HDMI (the registered trademark) terminal 2.

The south bridge 104 controls devices respectively on a PCI (Peripheral Component Interconnect) bus and devices respectively on an LPC (Low Pin Count) bus. Further, the south bridge 104 incorporates therein an IDE (Integrated Drive Electronics) controller which controls the HDD 109 and the ODD 110.

Further, the south bridge 104 also has a function for carrying out a communication with the sound controller 106.

The sound controller 106 is a sound source device to output audio data as an object to be reproduced to a speaker 18A, 18B or the HDMI (the registered trademark) control circuit 3. The LAN controller 108 is a wired communication device which carries out a wired communication of, for instance, an IEEE 802.3 standard. On the other hand, the wireless LAN controller 112 is a wireless communication device which carries out a wireless communication of, for instance, an IEEE 802.11g standard. The USB controller 111A carries out a communication with an external device which meets, for instance, a USB 2.0 standard.

For instance, the USB controller 111A is used to receive an image data file stored in a digital camera. Further, the card controller 111B writes and reads data to a memory card such as an SD card inserted into a card slot provided in a computer (a note PC) main body 11.

The EC/KBC 113 is a one-chip microcomputer in which an embed controller for controlling an electric power and a keyboard controller for controlling a keyboard 13 and a touch pad 16 are integrated. The EC/KBC 113 has a function for turning on/off a power source of the electronic device (the PC) 101 by an operation of a power button 14 by the user.

A control of a display in the present exemplary embodiment is carried out by, for instance, executing a program recorded in the system memory 103 or the HDD 109 by the CPU 101.

Here, as one example of the electronic device, the personal computer (the PC) is used to give an explanation. However, in the present exemplary embodiment, the electronic device is not limited to the PC, and may be realized by electronic devices such as a tablet, a smart phone or a television.

FIGS. 4A and 4B are diagrams showing an example of a structure of the control part which is provided in the electronic device (the PC) according to the exemplary embodiment to control a charge/discharge of the device of its own.

As shown in FIG. 4A, the control part includes a switch 22, a system 23, a battery charger 41 and a battery 42, and the switch 22 is provided between the system 23 and the battery 42, and between the battery charger 41 and the battery 42 as shown in the drawing.

Here, in the switch 22, its gate is controlled by, for instance, an EC/wireless device 21.

As described above, when the one switch (the FET switch) 22 is provided, a function can be mounted that inhibits a discharging operation (a feeding operation) from the battery 42 to the system 23.

Further, in this case, by an inner diode of the switch (the FET switch) 22, the battery 42 can be charged from the battery charger 41.

As shown in FIG. 4B, the control part includes a switch 22, a system 23, a battery charger 41 and a battery 42, and a switch 22a and a switch 22b are provided between the system 23 and the battery 42, and between the battery charger 41 and the battery 42.

Here, in the switch 22a and the switch 22b, their gates are respectively controlled by, for instance, an EC/wireless device 21.

As described above, when the two switches of the switch (the FET switch) 22a and the switch (FET switch) 22b are provided, a function can be mounted that inhibits a discharging operation (a feeding operation) from the battery 42 to the system 23 and a function can be mounted that inhibits a charging operation from the battery charger 41 to the battery 42.

FIG. 5 is a diagram showing a state that a mode for controlling the charge/discharge of the device of its own which is set to the electronic device (the PC) according to the exemplary embodiment is displayed and outputted to a display part of the electronic device (the PC) when the certification device (the wearable device) is not certified.

As shown in FIG. 5, in the present exemplary embodiment, the mode for controlling the charge/discharge of the device of its own (the electronic device (the PC) 101) is set to, for instance, the EEPROM 114 of the electronic device (the PC) 101 when the certification device (the wearable device) 103 is not certified.

Here, the mode for controlling the charge/discharge of the electronic device (the PC) 101 is generated so as to be displayed and outputted to, for instance, the display part of the electronic device (the PC) 101.

As for the mode for controlling the charge/discharge, for instance, in a “mode 1” 51, a “setting of the electronic device at the time of a non-certification” is set to a mode of an inhibition of the charge/discharge. At this time, the “first switch 22a” is set to OFF and the “second switch 22b” is set to OFF.

Further, in a “mode 2” 52, a “setting of the electronic device at the time of a non-certification” is set to a mode of a permission of the charge/an inhibition of the discharge.

At this time, the “first switch 22a” is set to ON and the “second switch 22b” is set to OFF.

Further, in a “mode 3” 53, a “setting of the electronic device at the time of a non-certification” is set to a mode of an inhibition of the charge/a permission of the discharge.

At this time, the “first switch 22a” is set to OFF and the “second switch 22b” is set to ON.

Further, in a “mode 4” 54, a “setting of the electronic device at the time of a non-certification” is set to a mode of a permission of the charge/discharge. At this time, the “first switch 22a” is set to ON and the “second switch 22b” is set to ON.

Further, in the above-described “mode 1” 51 to the “mode 4” 54, ordinarily, a security of the “mode 1” 51 is the highest and a security of the “mode 2” 52 is thirdly highest.

Further, a security of the “mode 3” 53 is secondly highest and a security of the “mode 4” 54 is fourthly highest.

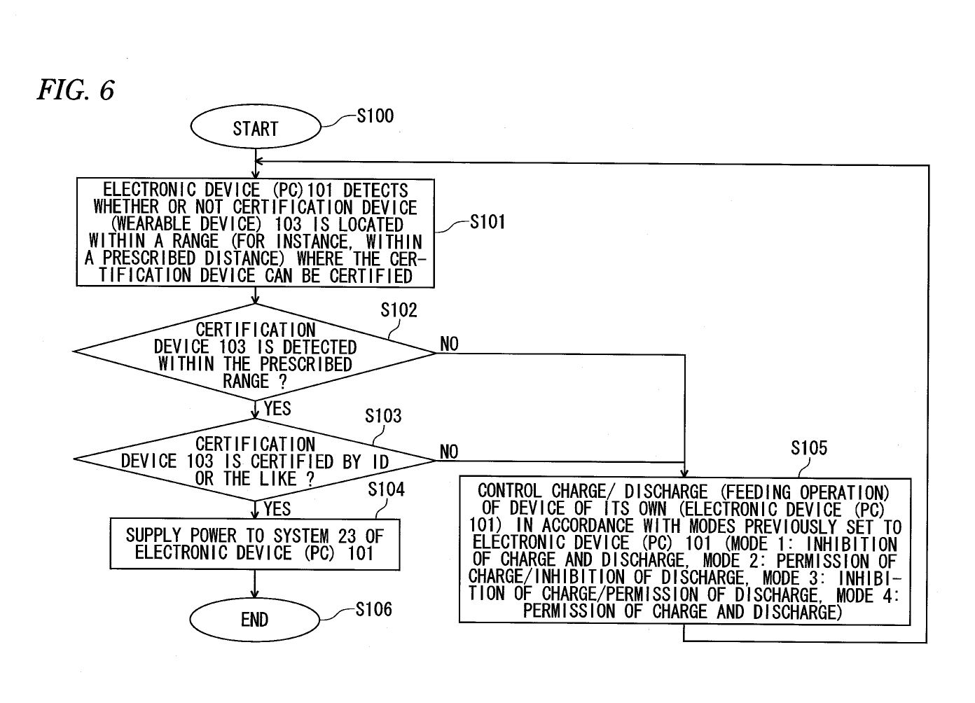

FIG. 6 is a flowchart for explaining an operation of the electronic device (the PC) according to the exemplary embodiment.

Step S100 is a start step in the flowchart. Then, a procedure advances to step S101.

The step S101 is a step which detects whether or not the certification device 103 (the wearable device) 103 is located within a range (for instance, within a prescribed distance where the certification device can be certified. Then, the procedure advances to step S102.

The step S102 is a step which detects whether or not the certification device 103 is located within a previously set prescribed range. When it is detected that the certification device 103 is located within the previously set prescribed range, the procedure advances to step S103 (Yes). When it is detected that the certification device 103 is not located within the previously set prescribed range, the procedure advances to step S105 (No).

The step S103 is a step which detects whether or not the certification device 103 is certified by, for instance, the ID. When it is detected that the certification device 103 is certified, the procedure advances to step S104 (Yes). When it is not detected that the certification device 103 is certified, the procedure advances to the step S105 (No).

The step S104 is a step which supplies a power to the system 23 of the electronic device (the PC) 101. Then, the procedure advances to step S106.

The step S105 is a step which controls the charge/discharge (a feeding operation) of the device of its own (the electronic device (the PC) 101 in accordance with the previously set modes to the electronic device (the PC) 101.

Here, for instance, the mode 1 shows the inhibition of the charge/discharge, the mode 2 shows the permission of the charge/the inhibition of the discharge, the mode 3 shows the inhibition of the charge/the permission of the discharge and the mode 4 shows the permission of the charge/discharge. Subsequently, the procedure advances to the step S101 to repeat the above-described processes.

The step S106 is an end step to finish the processes in the flowchart.

As described above, the electronic device according to the present exemplary embodiment includes the certification part (the CPU 101) which uses the certifying information outputted from the certification device (the wearable device) 103 having the use certifying function of the device of its own to certify the certification device 103.

Further, the electronic device includes the control part (the EC/wireless device 21, the load switch 22, the system 23 shown in FIGS. 2, 4A and 4B) which charges or discharges the device of its own or controls the device of its own to be charged or discharged in accordance with the modes (see FIG. 5) previously set to the device of its own when the certification device 103 is not certified.

The modes previously set to the device of its own include operation modes of the device of its own when the certification device 103 is not certified (see FIG. 6).

Further, the previously set mode permits the device of its own to be charged and inhibits the device of its own from being discharged (see FIG. 6).

Further, the previously set mode inhibits the device of its own from being charged and discharged (see FIG. 6).

Further, the first switch (the switch 22) is provided to operate the above-described set modes (see FIG. 4A).

Further, the first switch (the switch 22a) and the second switch (the switch 22b) are provided to operate the previously set modes (see FIG. 4B).

The electronic device includes a mode setting information output part which outputs information of the set modes (see FIG. 5).

Further, the electronic device includes a mode information output part which outputs information of the mode set to the device of its own (see FIG. 1).

Namely, in the present exemplary embodiment, for instance, when the ON/OFF of the battery line is controlled as described above, the battery can be inhibited from being charged and discharged, for instance, after the electronic device (the PC) 101 is stolen. Thus, a stronger security of the device can be realized.

Further, in the above-described exemplary embodiment, the setting of the security can be changed so as to meet use scenes or needs such as a double lock together with a password and a lock with an omission of a password.

Further, even when the certification device (the wearable device) 103 is not present near the electronic device (the PC) 101 (for instance, when the user who can certify the electronic device (PC) 101 is not present), the battery 42 can be permitted to be charged. Thus, the security and convenience can be realized at the same time.

Further, a proper use can be achieved, for instance, only the discharge is inhibited/only the charge is inhibited/both the charge and the discharge (the feeding operation) are inhibited (the inhibition of the charge and discharge) depending on cases of uses of an information device.

Further, for instance, when the certification device (the wearable device) 103 is more distant under a state that an OS of the electronic device (PC) 101 is activated, the EC/wireless device 21 does not immediately turn off the battery charging and discharging line. After the system 23 is shifted to a hibernation (contents of a memory are written in a storage, and then, a power source is turned off), the charge and discharge may be inhibited.

Namely, the electronic device (the PC) 101 can adjust the setting of the mode depending on the case of the use of the user.

According to the above-described structure, in the present exemplary embodiment, the electronic device (the PC or the like) can be provided which can be used even when the user himself or herself is absent who can be certified for the electronic device (the PC or the like) and is high in its security.

The procedure of control processes of the above-described exemplary embodiment is completely carried out by software. Accordingly, when a program is installed in an ordinary computer through a storage medium in which the program readable by the computer for executing the procedure of the control processes is stored and merely executed, the same effects as those of the above-exemplary embodiment can be easily realized.

The above-described exemplary embodiment is not limited to the description itself. In an embodying stage of the present invention, component elements may be variously modified and embodied within a range which does not deviate from a gist thereof.

Further, a plurality of component elements disclosed in the above-described exemplary embodiment is suitably combined together so that various inventions may be devised.

For instance, some component elements may be deleted from all the component elements shown in the exemplary embodiment. Further, component elements in different exemplary embodiments may be suitable combined together.

What is claimed is:

1. An electronic device comprising:
a certifier configured to certify a certification device based on certifying information from the certification device, wherein the certification comprises a use certifying function of the electronic device; and
a controller configured to control whether the electronic device is charged and/or discharged in accordance with a mode set for the electronic device when the certification device is not certified.

2. The electronic device according to claim 1, wherein
the mode corresponds to an operation mode of the electronic device when the certification device is not certified.

3. The electronic device according to claim 1, wherein
the mode permits the electronic device to be charged and inhibits the electronic device from being discharged.

4. The electronic device according to claim 1, wherein
the mode inhibits the electronic device from being both charged and discharged.

5. The electronic device according to claim 1, wherein
a first switch is provided to operate the mode.

6. The electronic device according to claim 1, wherein
a first switch and a second switch are provided to operate the mode.

7. The electronic device according to claim 1, further comprising
a first output configured to output mode setting information.

8. The electronic device according to claim 1, further comprising
a second output configured to output mode information.

9. The electronic device according to claim 1, wherein the second output is distinct from the first output.

10. A method of controlling an electronic device comprising:
certifying a certification device based on certifying information from the certification device, wherein certification comprises a use certifying function of the electronic device; and
controlling whether the electronic device is charged and/or discharged in accordance with a mode set for the electronic device when the certification device is not certified.

11. A non-transitory computer-readable medium containing program instructions for controlling an electronic device, wherein execution of the program instructions by one or more processors of a computer system causes the one or more processors to:
certify a certification device based on certifying information from the certification device, wherein certification comprises a use certifying function of the electronic device; and
control whether the electronic device is charged and/or discharged in accordance with a mode set for the electronic device when the certification device is not certified.
